(19) United States
(12) Patent Application Publication
(10) Pub. No.: US 2015/0002420 A1
(43) Pub. Date: Jan. 1, 2015

(54) MOBILE TERMINAL AND METHOD FOR CONTROLLING SCREEN

(71) Applicant: Samsung Electronics Co., Ltd., Suwon-si (KR)

(72) Inventor: Myung-Geun KOH, Yongin-si (KR)

(21) Appl. No.: 14/309,401

(22) Filed: Jun. 19, 2014

(30) Foreign Application Priority Data
Jun. 27, 2013 (KR) 10-2013-0074921

(51) Int. Cl. G06F 3/041

(52) U.S. Cl. CPC G06F 3/041
USPC 345/173

(57) ABSTRACT

A mobile terminal and a method for controlling a screen are provided. The method includes analyzing an approaching direction of an input unit on the screen, and determining an input mode of the screen in correspondence to the analysis.

### CROSS-REFERENCE TO RELATED APPLICATION(S)

This application claims the benefit under 35 U.S.C. §119(a) of a Korean patent application filed on Jun. 27, 2013 in the Korean Intellectual Property Office and assigned Serial number 10-2013-0074921, the entire disclosure of which is hereby incorporated by reference.

### TECHNICAL FIELD

The present disclosure relates to a mobile terminal. More particularly, the present disclosure relates to a mobile terminal and a method for controlling a screen.

### BACKGROUND

Currently, various services and additional functions that a mobile terminal provides are gradually increasing. In order to increase an effective value of the mobile terminal and meet various demands of users, a variety of applications which may be executed in the mobile terminal have been developed. Accordingly, at least several to hundreds of applications may be stored in the mobile terminal, such as a smart phone, a cellular phone, a notebook computer, or a tablet Personal Computer (PC), which may be carried and has a touch screen.

The mobile terminal has developed into a multimedia device which provides various multimedia services by using a data communication service as well as a voice call service in order to satisfy desires of a user. Further, the mobile terminal may display notes written on an input unit of the screen as it recognizes a touch or a hovering on the input unit. Further, the mobile terminal provides an additional input function for a left handed user or a right handed user in a setting menu to accurately recognize notes input by the user.

However, in the conventional mobile terminal, there is an inconvenience in that the mobile terminal fails to accurately recognize a touch point by the input unit when a hand of the user holding the input unit is changed, the mobile terminal is rotated or an option for which hand of the user is used, that must be reset each time the hand used by the user is changed.

In the case where the input unit is used, there is a problem in that an actual touch point of the input unit viewed by the user may be recognized to be different from a touch point recognized by the mobile terminal according to the hand used by the user holding the input unit and a placement status of the mobile terminal. Therefore, it is required to actively solve and improve the problem.

Accordingly, a mobile terminal and a method for controlling a screen, which is capable of actively compensating for a coordinate on a screen through an approaching direction of an input unit and a rotation status of the mobile terminal so that a user' sight is identical to the coordinate of the screen recognizing a location of an input unit, even though an option for a hand of a user is not set in an environment setting screen when the user uses the input unit is desired.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problem and/or disadvantages and to provide at least the advantages described below. Accordingly, an aspect of the present disclosure is to provide a mobile terminal and a method for controlling a screen.

Another aspect of the present disclosure is to provide a mobile terminal and a method for controlling a screen, which is capable of actively compensating for a coordinate on a screen through an approaching direction of an input unit and a rotation status of the mobile terminal so that a user' sight is identical to the coordinate of the screen recognizing a location of an input unit, even though an option for a hand of a user is not set in an environment setting screen when the user uses the input unit.

In accordance with an aspect of the present disclosure, a method for controlling a screen of a mobile terminal is provided. The method includes analyzing an approaching direction of an input unit on the screen, determining an input mode of the screen in correspondence to the analysis.

In accordance with another aspect of the present disclosure, a method for controlling a screen of a mobile terminal is provided. The method includes analyzing an approaching direction of an input unit on the screen, selecting an input mode corresponding to the analyzed approaching direction, and applying the selected input mode as an input mode of the screen.

In accordance with still another aspect of the present disclosure, a mobile terminal for controlling a screen is provided. The mobile terminal includes a screen which supplies notes, and a controller which analyzes an approaching direction of the input unit on the screen and controls determination of an input mode of the screen in correspondence to the analysis.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram schematically illustrating a mobile terminal according to an embodiment of the present disclosure;

FIG. 2 is a perspective view illustrating a mobile terminal, in which a front surface of the mobile terminal is shown according to an embodiment of the present disclosure;

FIG. 3 is a perspective view illustrating a mobile terminal, in which a rear surface of a mobile terminal is shown according to an embodiment of the present disclosure;

FIG. 4 is an exploded view schematically illustrating a screen, in which an input unit is hovering on the screen according to an embodiment of the present disclosure;

FIG. 5 is a block diagram illustrating an input unit according to an embodiment of the present disclosure;

FIG. 6 is a flowchart illustrating a process of setting a screen mode of a mobile terminal according to an embodiment of the present disclosure;

FIG. 7A is a front view illustrating a mobile terminal, in which an input unit approaches a screen of the mobile terminal according to an embodiment of the present disclosure;

FIG. 7B is a front view illustrating a mobile terminal, in which an input unit approaches a screen of the mobile terminal according to an embodiment of the present disclosure;

FIG. 7C is a front view illustrating a mobile terminal, in which the mobile terminal rotates by 180 degrees clockwise and an input unit approaches a screen of the mobile terminal according to an embodiment of the present disclosure;

FIG. 7D is a front view illustrating a mobile terminal, in which the mobile terminal rotates by 180 degrees clockwise from the status of FIG. 7A and an input unit approaches a screen of the mobile terminal according to an embodiment of the present disclosure;

FIG. 7E is a front view illustrating a mobile terminal, in which the mobile terminal rotates by 90 degrees clockwise from the status of FIG. 7A and an input unit approaches a screen of the mobile terminal according to an embodiment of the present disclosure;

FIG. 7F is a front view illustrating a mobile terminal, in which the mobile terminal rotates by 90 degrees clockwise from the status of FIG. 7A and an input unit approaches a screen of the mobile terminal according to an embodiment of the present disclosure;

FIG. 7G is a front view illustrating a mobile terminal, in which the mobile terminal rotates by 270 degrees clockwise from the status of FIG. 7A and an input unit approaches a screen of the mobile terminal according to an embodiment of the present disclosure;

FIG. 7H is a front view illustrating a mobile terminal, in which the mobile terminal rotates by 270 degrees clockwise from the status of FIG. 7A and an input unit approaches a screen of the mobile terminal according to an embodiment of the present disclosure; and

FIG. 8 is a flowchart illustrating a process of converting a screen mode of the mobile terminal according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Unless defined differently, all terms used herein, which include technical terminologies or scientific terminologies, have the same meaning as a person skilled in the art, to which the present disclosure belongs. It should be interpreted that the terms, which are identical to those defined in general dictionaries, have the meaning identical to that in the context of the related technique. The terms should not be ideally or excessively interpreted as a formal meaning.

Hereinafter, an operation principle of various embodiments of the present disclosure will be described in detail with reference to the accompanying drawings. A detailed description of known functions and configurations incorporated herein will be omitted as it may make the subject matter of the present disclosure rather unclear. The terms which will be described below are terms defined in consideration of the functions in the present disclosure, and may be different according to users, intentions of the users, or customs. Accordingly, the terms should be defined based on the contents over the whole present specification.

Firstly, terms used in the present disclosure will be defined as follows.

A mobile terminal is defined as a portable terminal for performing a voice call, a video call, and a transmission and reception of data, which may be carried and has at least one screen (e.g., a touch screen). Such a mobile terminal includes a smart phone, a tablet Personal Computer (PC), a 3D-Television (TV), a smart TV, a Light Emitting Diode (LED) TV, and a Liquid Crystal Display (LCD) TV, and also includes all terminals which may communicate with a peripheral device and/or another terminal located at a remote place.

An input unit includes at least one of an electronic pen and a stylus pen which may provide a command or an input to the mobile terminal in a screen contact state and/or a non-contact state such as hovering.

An object includes at least one of a document, a widget, a picture, a map, a video, an E-mail, an SMS message, and an MMS message, which is displayed or is able to be displayed on the screen of the mobile terminal, and may be executed, deleted, canceled, saved and changed by the input unit. The object may also be used as a comprehensive meaning that includes a shortcut icon, a thumbnail image, and a folder storing at least one object in the portable terminal.

A shortcut icon is displayed on the screen of the mobile terminal in order to quickly execute an application such as a call, a contact, a menu and the like which are basically provided to the mobile terminal, and executes a corresponding application when an instruction or an input for the execution of the application is input.

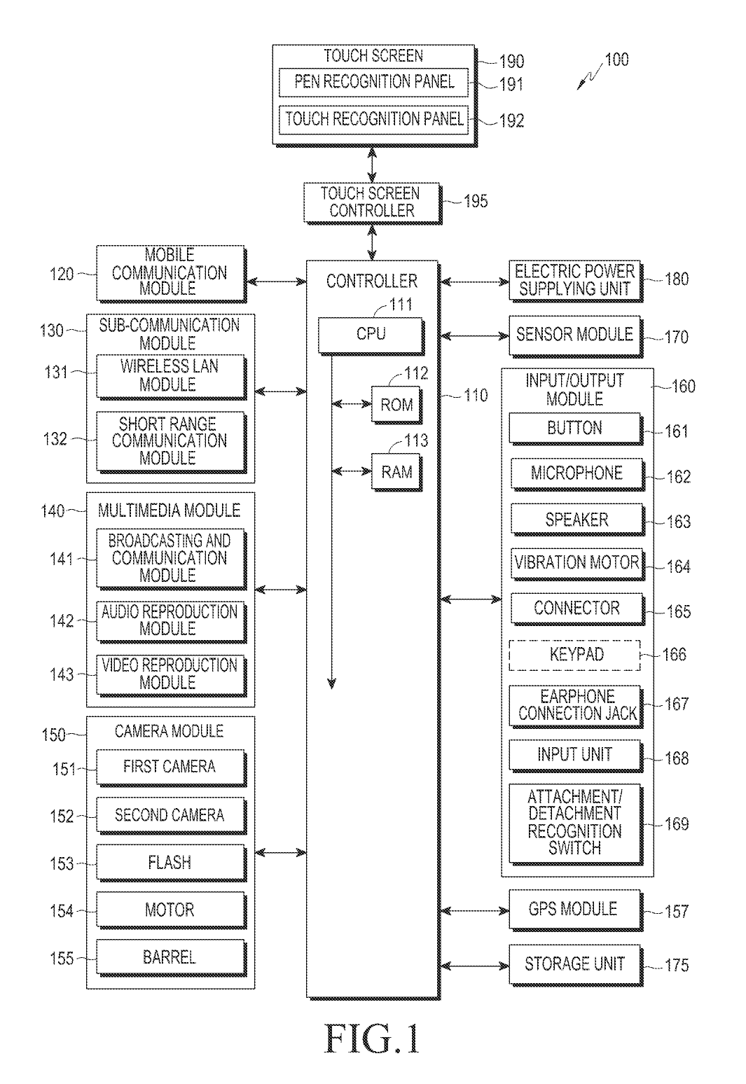

FIG. 1 is a block diagram schematically illustrating a mobile terminal according to an embodiment of the present disclosure.

Referring to FIG. 1, the mobile terminal 100 may be connected with an external device (not shown) by using at least one of a mobile communication module 120, a sub-communication module 130, a connector 165, and an earphone connection jack 167. The external device may include various devices detachably attached to the mobile terminal 100 by a wire, such as an earphone, an external speaker, a Universal Serial Bus (USB) memory, a charger, a cradle/dock, a Digital Multimedia Broadcasting (DMB) antenna, a mobile payment related device, a health management device (blood sugar tester or the like), a game machine, a car navigation device and the like. Further, the external device may include a Bluetooth communication device, a Near Field Communication (NFC) device, a WiFi Direct communication device, and a wireless Access Point (AP) which may wirelessly access a network. The mobile terminal may be connected with other devices (i.e., a cellular phone, a smart phone, a tablet PC, a desktop PC, and a server) in a wired or wireless manner.

Referring to FIG. 1, the mobile terminal 100 includes at least one touch screen 190 and at least one touch screen controller 195. The touch screen 190 may include at least one panel according to an instruction input manner, and the touch controller 195 may be provided to each panel which recognizes and transmits an instruction input through the screen to the controller 110. The touch screen 190 may include a pen recognition panel 191 for recognizing a pen performing an input through a touch and/or a hovering and a touch recognition panel 192 for recognizing a touch using a finger. Further, the screen controller 195 may include a pen recognition controller (not shown) for transmitting the instruction detected by the pen recognition panel 191 to the controller 110 and a touch recognition controller (not shown) for transmitting the instruction by the touch recognition panel 192 to the controller 110. Also, the mobile terminal 100 includes the controller 110, a mobile communication module 120, a sub-communication module 130, a multimedia module 140, a camera module 150, a GPS module 157, an input/output module 160, a sensor module 170, a storage unit 175, and a power supply unit 180, but is not limited thereto.

The sub-communication module 130 includes at least one of a wireless Local Area Network (LAN) module 131 and a short range communication module 132, and the multimedia module 140 includes at least one of a broadcasting and communication module 141, an audio reproduction module 142, and a video reproduction module 143. The camera module 150 includes at least one of a first camera 151 and a second camera 152. Further, the camera module 150 of the mobile terminal 100 according to the present disclosure includes at least one of a barrel 155 for zooming in/zooming out the first and/or second cameras 151 and 152, a motor 154 for controlling a motion of the barrel 155 to zoom in/zoom out the barrel 155, and a flash 153 for providing light for photographing according to a main purpose of the mobile terminal 100. The input/output module 160 may include at least one of a button 161, a microphone 162, a speaker 163, a vibration motor 164, a connector 165, and a keypad 166.

The controller 110 may include a CPU 111, a ROM 112 which stores a control program for controlling the user terminal 100, and a RAM 113 which stores signals or data input from the outside of the user terminal 100 or is used as a memory region for an operation executed in the mobile terminal 100. The CPU 111 may include a single core type CPU, and a multi-core type CPU such as a dual core type CPU, a triple core type CPU, or a quad core type CPU. The CPU 111, the ROM 112 and the RAM 113 may be connected to one other through internal buses.

Further, the controller 110 may control the mobile communication module 120, the sub-communication module 130, the multimedia module 140, the camera module 150, the GPS module 157, the input/output module 160, the sensor module 170, the storage unit 175, the electric power supplying unit 180, the touch screen touch 190, and the screen controller 195.

Further, the controller 110 determines whether the hovering is recognized as the touchable input unit 168 such as the electronic pen approaches one object in a state where a plurality of objects is displayed on the screen touch 190 and identifies the object corresponding to a position where the hovering occurs. Furthermore, the controller 110 may detect a height from the mobile terminal 100 to the input unit and a hovering input event according to the height, and the hovering input event may include at least one of a press of a button formed on the input unit, a knocking on the input unit, a movement of the input unit with a speed faster than a predetermined speed, and a touch of the object.

Moreover, the controller 110 analyzes an approaching direction of the input unit on the touch screen 190, and determines an input mode of the touch screen 190 in correspondence to the result of the analysis. The input mode includes at least one of an input mode through a touch on the screen, and an input mode through a touch or a hovering of the input unit on the screen. The input mode described below may be applied to at least one of the touch input mode and the hovering input mode described above. In addition, the input mode includes at least one of a writing mode for writing notes using the input unit or a finger and a drawing mode for drawing a picture. Further, the controller 110 applies a predetermined coordinate value corresponding to the determined input mode. The controller 110 adds the predetermined coordinate value to a coordinate value of the screen. Furthermore, the controller 110 analyzes an approaching direction of the input unit through a first region in which an input of the input unit is detected and a second region distinguished from the first region, to which the input unit moves. In addition, the controller 110 may analyze the approaching direction of the input unit through a point (or region) at which the input of the input unit is detected and a point (or region) at which an input is detected after a predetermined time lapse. The controller 110 may analyze the approaching direction of the input unit through an area (or point) in which an initial hovering input of the input unit is detected and an area (or point) in which the input unit touches the screen. Further, the controller 110 determines the input mode of the screen with reference to the approaching direction of the input unit and the rotation status or angle of the mobile terminal. When the mobile terminal rotates by a predetermined angle, the controller 110 may determine a rotation angle of the mobile terminal.

On the other hand, the predetermined coordinate value is defined in a table form according to the approaching direction of the input unit and the rotation angle of the mobile terminal. The mobile terminal may rotate in a range of 0 to 360 degrees, and the controller 110 may identify the rotation angle of the mobile terminal. That is, the controller 110 may determine whether a hand holding the input unit is a left hand or a right hand by analyzing the approaching direction of the input unit. Further, the controller 110 may determine whether the mobile terminal is placed at an initial status, rotates by 90 degrees, rotates by 180 degrees, or rotates by 270 degrees clockwise with respect to the initial status. Further, the controller 110 may determine a specific rotation angle by 1 degree through the sensor module 170.

In addition, the controller 110 analyzes the approaching direction or a progressing direction of the input unit to the screen, selects an input mode corresponding to the analyzed approaching direction, and applies the selected input mode as the input mode of the screen. In the applied input mode, a coordinate of the screen moves by a coordinate value corresponding to the selected input mode. The controller 110 analyzes the approaching direction of the input unit through an area (or point) in which the initial hovering input of the input unit is detected and an area (or point) in which the input unit touches the screen. The controller 110 determines the hand holding the input unit through the approaching direction of the input unit. Further, the input mode is selected by using the approaching direction of the input unit and the rotation status of the mobile terminal. In addition, the controller 110 analyzes at least one of the approaching direction and the changed status of the portable terminal in correspondence to at least one of a re-approaching direction of the input unit and a changed rotation status of the portable terminal, and selects the input mode corresponding to the analyzed approaching direction. The controller 110 selects a mode to be applied to the screen from a plurality of input modes which were previously stored according to the approaching direction of the input unit and the rotation angle of the mobile terminal by using the result of analyzing the approaching direction of the input unit and the rotation angle of the mobile terminal. Further, when it is detected that the screen detects the approaching of the input unit, the controller 110 determines a hand holding the input unit through the approaching of the input unit, and maintains the screen in the previously applied input mode.

The mobile communication module 120 enables the mobile terminal 100 to be connected with the external device through mobile communication by using one or more antennas under a control of the controller 110. The mobile communication module 120 transmits/receives a wireless signal for a voice call, a video call, a Short Message Service (SMS), or a Multimedia Message Service (MMS) to/from a mobile phone (not shown), a smartphone (not shown), a tablet PC, or another device (not shown), which has a phone number input into the mobile terminal 100.

The sub-communication module 130 may include at least one of the wireless LAN module 131 and the short-range communication module 132. For example, the sub-communication module 130 may include only the wireless LAN module 131, only the short-range communication module 132, or both the wireless LAN module 131 and the short-range communication module 132.

The wireless LAN module 131 may be connected to the Internet in a place where a wireless AP (not shown) is installed, under a control of the controller 110. The wireless LAN module 131 supports a wireless LAN standard (IEEE802.11x) of the Institute of Electrical and Electronics Engineers (IEEE). The short-range communication module 132 may perform the short-range communication wirelessly between the mobile terminal 100 and an image forming apparatus (not shown) under the control of the control unit 110. A short-range communication scheme may include a Bluetooth communication scheme, an Infrared Data Association (IrDA) communication scheme, a WiFi-Direct communication scheme, a NFC scheme and the like.

According to the performance, the mobile terminal 100 may include at least one of the mobile communication module 120, the wireless LAN module 131, and the short-range communication module 132. Further, the mobile terminal 100 may include a combination of the mobile communication module 120, the wireless LAN module 131, and the local area communication module 132, according to the performance thereof. In the present disclosure, at least one or combinations of the mobile communication module 120, the wireless LAN module 131, and the NFC module 132 are referred to as a transceiver, without limiting the scope of the present disclosure.

The multimedia module 140 may include the broadcasting and communication module 141, the audio reproduction module 142, or the video reproduction module 143. The broadcasting and communication module 141 may receive a broadcasting signal (e.g., a TV broadcasting signal, a radio broadcasting signal, or a data broadcasting signal), and broadcasting supplement information (e.g., Electric Program Guide (EPG) or Electric Service Guide (ESG)) output from a broadcasting station through a broadcasting communication antenna (not shown) under the control of the controller 110. The audio reproduction module 142 may reproduce a stored or received digital audio file (e.g., a file having a file extension of mp3, wma, ogg, or way), under a control of the controller 110. The video reproduction module 143 may reproduce a stored or received digital video file (e.g., a file of which the file extension is mpeg, mpg, mp4, avi, mov, or mkv), under the control of the controller 110. The video reproduction module 143 may reproduce a digital audio file.

The multimedia module 140 may include the audio reproduction module 142 and the video reproduction module 143 except for the broadcasting and communication module 141. Further, the audio reproduction module 142 or the video reproduction module 143 of the multimedia module 140 may be included in the controller 110.

The camera module 150 may include at least one of the first camera 151 and the second camera 152 which photograph a still image or a video under the control of the controller 110. Further, the camera module 150 may include at least one of the barrel 155 performing a zoom-in/out for photographing a subject, the motor 154 controlling a movement of the barrel 155, and the flash 153 providing an auxiliary light required for photographing the subject. The first camera 151 may be disposed on a front surface of the mobile terminal 100, and the second camera 152 may be disposed on a rear surface of the mobile terminal 100. Alternatively, the first camera 151 and the second camera 152 are disposed to be adjacent to each other (e.g., a distance between the first camera 151 and the second camera 152 is larger than 1 cm and smaller than 8 cm), to photograph a three-dimensional still image or a three-dimensional video.

Each of the first and second cameras 151 and 152 includes a lens system, an image sensor and the like. The first and second cameras 151 and 152 convert optical signals input (or taken) through the lens system into electric image signals, and output the electric image signals to the controller 110. A user takes a video or a still image through the first and second cameras 151 and 152.

The GPS module 157 may receive radio waves from a plurality of GPS satellites (not shown) in Earth's orbit and calculate a position of the mobile terminal 100 by using Time of Arrival information from the GPS satellites to the mobile terminal 100.

The input/output module 160 may include at least one of a plurality of buttons 161, the microphone 162, the speaker 163, the vibration motor 164, the connector 165, the keypad 166, the earphone connection jack 167, and the input unit 168. The input/output module is not limited thereto, and a cursor controller such as a mouse, a trackball, a joystick, or cursor direction keys may be provided to control a movement of the cursor on the touch screen 190.

The buttons 161 may be formed on the front surface, side surfaces or rear surface of the housing of the mobile terminal 100 and may include at least one of a power/lock button (not shown), a volume control button (not shown), a menu button, a home button, a back button, and a search button 161.

The microphone 162 receives a voice or a sound to generate an electrical signal under the control of the controller 110.

The speaker 163 may output sounds corresponding to various signals of the mobile communication module 120, the sub-communication module 130, the multimedia module 140, and the camera module 150 (e.g., a radio signal, a broadcast signal, a digital audio file, a digital video file, or photographing), to the outside of the mobile terminal 100 under the control of the controller 110. The speaker 163 may output a sound (e.g., button tone corresponding to voice call, or ring tone, corresponding to a function performed by the mobile terminal 100). One or more speakers 163 may be formed on a suitable position or positions of the housing of the mobile terminal 100.

The vibration motor 164 is capable of converting electric signals into mechanical vibrations under a control of the controller 110. For example, when the mobile terminal 100 in a vibration mode receives a voice call from any other device (not illustrated), the vibration motor 164 operates. One or more vibration motors 164 may be provided in the housing of the mobile terminal 100. The vibration motor 164 may operate in response to a touch action of the user made on the touch screen 190 or successive movements of the touch on the touch screen 190.

The connector 165 may be used as an interface for connecting the mobile terminal with an external device (not shown) or a power source (not shown). The mobile terminal 100 may transmit or receive data stored in the storage unit 175 of the mobile terminal 100 to or from an external device (not shown) through a wired cable connected to the connector 165 according to a control of the controller 110. Further, the mobile terminal 100 may be supplied with electric power from the electric power source through the wired cable connected to the connector 165 or charge a battery (not shown) by using the electric power source.

The keypad 166 may receive a key input from a user for control of the mobile terminal 100. The keypad 166 includes a physical keypad (not shown) formed in the mobile terminal 100 or a virtual keypad (not shown) displayed on the touch screen 190. The physical keypad (not shown) formed on the mobile terminal 100 may be excluded according to the capability or configuration of the mobile terminal 100.

An earphone (not shown) may be inserted into the earphone connection jack 167 to be connected to the mobile terminal 100, and the input unit 168 may be inserted into and preserved in the mobile terminal 100 and may be extracted or detached from the mobile terminal 100 when not being used. In addition, an attachment/detachment recognition switch 169 operating in response to attachment or detachment of the input unit 168 is provided at one area within the mobile terminal 100 into which the input unit 168 is inserted, and may provide a signal corresponding to the attachment or detachment of the input unit 168 to the controller 110. The attachment/detachment recognition switch 169 is located at one area into which the input unit 168 is inserted to directly or indirectly contact the input unit 168 when the input unit 168 is mounted. Accordingly, the attachment/detachment recognition switch 169 generates a signal corresponding to the attachment or the detachment of the input unit 168 based on the direct or indirect contact with the input unit 168 and then provides the generated signal to the controller 110.

The sensor module 170 includes at least one sensor for detecting a status of the mobile terminal 100. For example, the sensor module 170 may include a proximity sensor that detects a user's proximity to the mobile terminal 100, an illumination sensor (not shown) that detects a quantity of light around the mobile terminal 100, a motion sensor (not shown) that detects a motion (e.g., rotation of the mobile terminal 100 and acceleration or a vibration applied to the mobile terminal 100), of the mobile terminal 100, a geo-magnetic sensor (not shown) that detects a point of a compass by using Earth's magnetic field, a gravity sensor that detects an action direction of the Gravity, and an altimeter that detects an altitude through measuring an atmospheric pressure. At least one sensor may detect the status, and may generate a signal corresponding to the detection to transmit the generated signal to the controller 110. The sensor of the sensor module 170 may be added or excluded according to a performance of the mobile terminal 100.

The storage unit 175 may store an input/output signal or data corresponding to the operation of the mobile communication module 120, the sub-communication module 130, the multimedia module 140, the camera module 150, the GPS module 157, the input/output module 160, the sensor module 170, or the touch screen 190. The storage unit 175 may store a control program and applications for controlling the mobile terminal 100 or the controller 110.

The term “storage unit” refers to the storage unit 175, the ROM 112 and the RAM 113 within the controller 110, or a memory card mounted on the mobile terminal 100 (e.g., a Secure Digital (SD) card or a memory stick). Further, the storage unit may include a nonvolatile memory, a volatile memory, a Hard Disk Drive (HDD), or a Solid State Drive (SSD).

Further, the storage unit 175 may store applications such as a navigation application, a video call application, a game application, a one on one conversation application, a multi-user conversation application, an alarm application based on time, which have different functions, images for providing a Graphical User Interface (GUI) relating to the applications, databases or data relating to a method of processing user information, a document and a touch input, background images or operation programs (i.e., a menu screen, a standby screen, and the like), necessary for an operation of the mobile terminal 100, images captured by the camera module 150, and the like. The storage unit 175 is a machine-readable medium (e.g., a computer readable medium). The term “machine-readable medium” may be defined as a medium capable of providing data to the machine so that the machine performs a specific function. The machine-readable medium may be a storage medium. The storage unit 175 may include a non-volatile medium and a volatile medium. All of these media should be of a type that allows the instructions transferred by the medium to be detected by a physical instrument in which the machine reads the instructions into the physical instrument.

The machine-readable medium is not limited thereto and includes at least one of a floppy disk, a flexible disk, a hard disk, a magnetic tape, a Compact Disk Read-Only Memory (CD-ROM), an optical disk, a punch card, a paper tape, a Read-Only Memory (RAM), a Programmable ROM (PROM), an Erasable PROM (EPROM), and a flash-EPROM.

The electric power supplying unit 180 may supply electric power to one or more batteries (not shown) provided to the mobile terminal 100 under the control of the controller 110. The one or more batteries (not shown) supply electric power to the mobile terminal 100. Further, the electric power supplying unit 180 may supply electric power input from an external electric power source (not shown) to the mobile terminal 100 through a wired cable connected to the connector 165. In addition, the electric power supplying unit 180 may supply electric power wirelessly input from the external electric power source through a wireless charging technology to the mobile terminal 100.

Further, the mobile terminal 100 may include at least one screen providing user interfaces corresponding to various services (e.g., a voice call, data transmission, broadcasting, and photography), to the user. Each screen may transmit an analog signal, which corresponds to at least one touch and/or at least one hovering input in a user interface, to a corresponding screen controller 195. As described above, the mobile terminal 100 may include a plurality of screens, and each of the screens may include a screen controller receiving an analog signal corresponding to a touch. Each screen may be connected with plural housings through hinge connections, respectively, or the plural screens may be located at one housing without the hinge connection. As described above, the mobile terminal 100 according to the present disclosure may include at least one screen. Hereinafter, the mobile terminal 100 including one screen will be described, for convenience of description.

The touch screen 190 may receive at least one touch through a user's body (e.g., fingers including a thumb), or a touchable input unit (e.g., a stylus pen or an electronic pen). The touch screen 190 may include a touch recognition panel 192 which recognizes an input of an instruction when the instruction is input by a touch of a user's body and a pen recognition panel 191 which recognizes an input of an instruction when the instruction is input by a pen such as a stylus pen or an electronic pen. Such a pen recognition panel 191 may identify a distance between the pen and the touch screen 190 through a magnetic field, and transmit a signal corresponding to the input instruction to a pen recognition controller (not shown) provided to the screen controller 195. Further, the pen recognition panel 191 may identify a distance between the pen and the touch screen 190 through the magnetic field, an ultrasonic wave, optical information and a surface acoustic wave. In addition, the touch recognition screen 192 may receive a continuous motion of one touch among one or more touches. The touch recognition panel 192 may transmit an analog signal corresponding to the continuous motion of the input touch to the touch recognition controller (not shown) provided to the screen controller 195. The touch recognition panel 192 may detect a position of a touch by using an electric charge moved by the touch. The touch recognition panel 192 may detect all touches capable of generating static electricity, and also may detect a touch of a finger or a pen which is an input unit. On the other hand, the screen controller 195 may have different controllers according to the instruction to be input, and may further include a controller corresponding to an input by biomedical information such as the pupil of eyes of a user.

Moreover, in the present disclosure, the touch is not limited to a contact between the touch screen 190 and the user's body or a touchable input means, and may include a non-contact (e.g., hovering). In the non-contact (i.e., hovering), the controller 110 may detect a distance from the touch screen 190 to the hovering, and the detectable distance may be varied according to the performance or the configuration of the mobile terminal 100. Especially, the touch screen 190 may configured to distinctively detect a touch event by a contact with a user's body or a touchable input unit, and the non-contact input event (i.e., a hovering event). In other words, the touch screen 190 may output values (i.e., analog values including a voltage value and an electric current value), detected through the touch event and the hovering event in order to distinguish the hovering event from the touch event. Furthermore, it is preferable that the touch screen 190 outputs different detected values (e.g., a current value or the like), according to a distance between a space where the hovering event is generated and the touch screen 190.

The touch screen 190 may be implemented in a resistive type, a capacitive type, an infrared type, or an acoustic wave type.

Further, the touch screen 190 may include two or more screen panels which may detect touches and/or approaches of the user's body and the touchable input unit respectively in order to sequentially or simultaneously receive inputs by the user's body and the touchable input unit. The two or more screen panels provide different output values to the screen controller, and the screen controller may differently recognize the values input into the two or more touch screen panels to distinguish whether the input from the touch screen 190 is an input by the user's body or an input by the touchable input unit. Further, the touch screen 190 displays one or more objects.

More particularly, the touch screen 190 may be formed in a structure in which a panel detecting the input by the input unit 168 through a change in an induced electromotive force and a panel detecting the contact between the touch screen 190 and the finger are sequentially laminated in a state where the panels are attached to each other or partially separated from each other. The touch screen 190 includes a plurality of pixels and displays an image through the pixels. A Liquid Crystal Display (LCD), an Organic Light Emitting Diode (OLED), or a Light Emitting Diode (LED) may be used as the touch screen 190.

Further, the touch screen 190 includes a plurality of sensors for detecting a position of the input unit when the input unit 168 touches or is spaced at a predetermined distance from a surface of the touch screen 190. The plurality of sensors may be individually formed with a coil structure, and in a sensor layer formed of the plurality of sensors, the sensors are arranged in a predetermined pattern and form a plurality of electrode lines. In this structure, when the input unit 168 touches or hovers on the touch screen 190, a detection signal, of which a waveform is changed due to a magnetic field between the sensor layer and the input unit, is generated, and the touch screen 190 transmits the generated detection signal to the controller 110. Further, when the finger touches the touch screen 190, the touch screen 190 transmits a detection signal caused by electrostatic capacity to the controller 110. On the other hand, a distance between the input unit 169 and the touch screen 190 may be known through intensity of a magnetic field created by the coil. Hereinafter, a process of setting intensity of the vibration will be described.

The touch screen 190 executes an application (e.g., a memo application, a diary application, a messenger application, and the like), which allows the user to input a message or a picture with the input unit or a finger. Further, the touch screen 190 displays an input message through an executed application. The touch screen 190 converts a current input mode to a determined input mode under the control of the controller 110. Further, the controller 110 applies a predetermined coordinate value corresponding to the determined input mode. The predetermined coordinate value is differently allocated depending on various modes of the touch screen 190, and is previously stored in the mobile terminal 100. The touch screen 190 detects a touch of the input unit or an approaching of the input unit (i.e., hovering), and detects the input of the input unit again after a predetermined time lapses. The touch screen 190 may determine the approaching direction or the progressing direction of the input unit through an area (or point) in which the touch of the input unit or the approaching of the input unit (i.e., hovering), is detected and an area (or point) of the screen in which a touch input is detected. Further, the touch screen 190 applies the predetermined coordinate value according to the approaching direction of the input unit and/or the rotation state of the mobile terminal under the control of the controller 110.

Meanwhile, the screen controller 195 converts an analog signal received from the touch screen 190 to a digital signal (e.g., X and Y coordinates), and transmits the converted digital signal to the controller 110. The controller 110 may control the touch screen 190 by using the digital signal received from the screen controller 195. For example, the controller 110 may allow a short-cut icon (not shown) or an object displayed on the touch screen 190 to be selected or executed in response to a touch event or a hovering event. Further, the screen controller 195 may be included in the controller 110.

Furthermore, the screen controller 195 may identify a distance between a space where the hovering event is generated and the touch screen 190 by detecting a value (e.g., a current value or the like), output through the touch screen 190, convert the identified distance value to a digital signal (e.g., a Z coordinate), and then provide the converted digital signal to the controller 110.

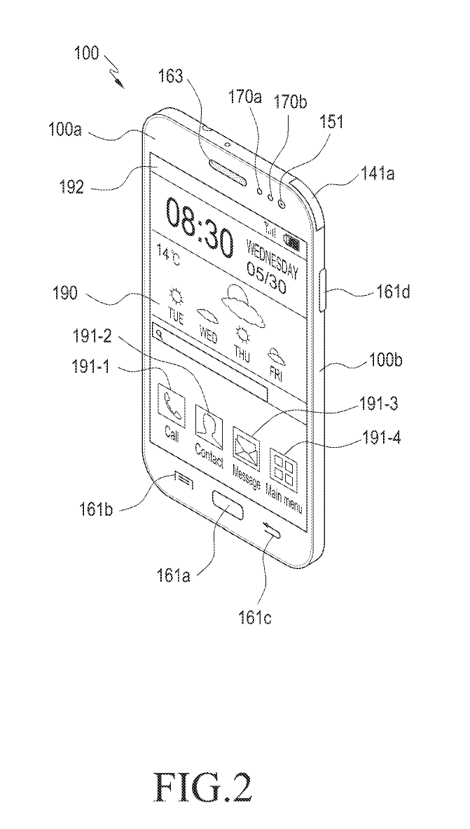

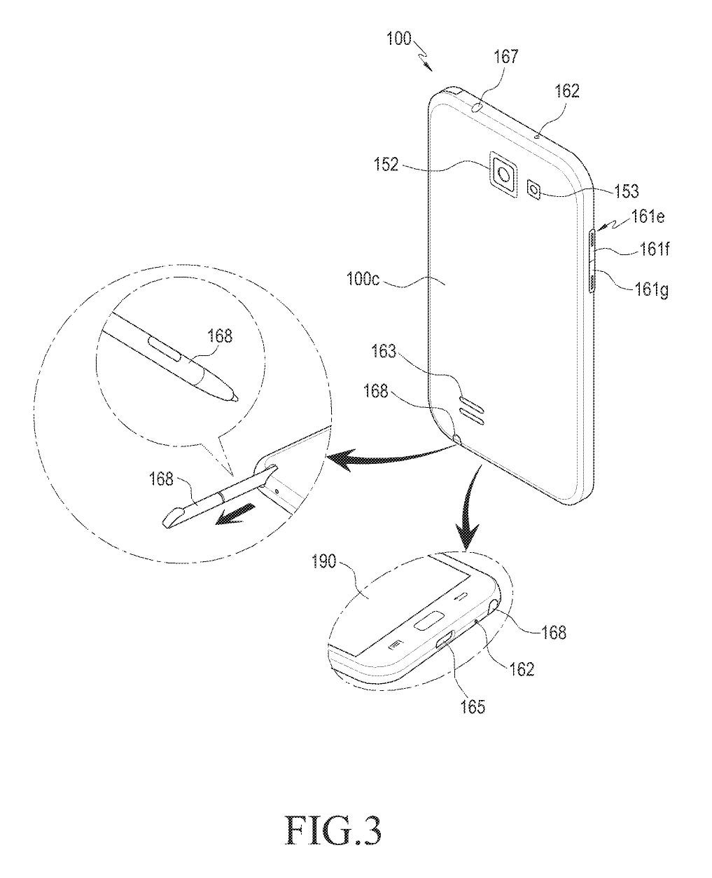

FIG. 2 is a perspective view illustrating a mobile terminal, in which a front surface of the mobile terminal is shown according to an embodiment of the present disclosure, and FIG. 3 is a perspective view illustrating the mobile terminal, in which a rear surface of the mobile terminal is shown according to an embodiment of the present disclosure.

Referring to FIGS. 2 and 3, the touch screen 190 is disposed at the center portion of the front surface 100a of the mobile terminal 100. The touch screen 190 may have a large size to occupy most of the front surface 100a of the mobile terminal 100. FIG. 2 shows an example of a main home screen displayed on the touch screen 190. The main home screen is a first screen displayed on the touch screen 190 when electric power of the mobile terminal 100 is turned on. Further, when the mobile terminal 100 has different home screens of several pages, the main home screen may be a first home screen of the home screens of several pages. Short-cut icons 191-1, 191-2 and 191-3 for executing frequently used applications, a main menu switching key 191-4, time, weather and the like may be displayed on the home screen. The main menu switching key 191-4 displays a menu screen on the touch screen 190. Further, a status bar 192 which displays a status of the mobile terminal 100 such as a battery charging status, intensity of a received signal, and a current time may be formed on an upper end of the touch screen 190.

A home button 161a, a menu button 161b, and a back button 161c may be formed at a lower portion of the touch screen 190.

The home button 161a displays the main home screen on the touch screen 190. For example, when the home button 161a is touched in a state where a home screen different from the main home screen or the menu screen is displayed on the touch screen 190, the main home screen may be displayed on the touch screen 190. Further, when the home button 161a is touched while applications are executed on the touch screen 190, the main home screen shown in FIG. 2 may be displayed on the touch screen 190. In addition, the home button 161a may be used to display recently used applications or a task manager on the touch screen 190.

The menu button 161b provides a connection menu which may be used on the touch screen 190. The connection menu includes a widget addition menu, a background changing menu, a search menu, an editing menu, an environment setup menu and the like.

The back button 161c may be used for displaying the screen which was executed just before the currently executed screen or terminating the most recently used application.

The first camera 151, the illumination sensor 170a, and the proximity sensor 170b may be disposed on edges of the front side 100a of the mobile terminal 100. The second camera 152, the flash 153, and the speaker 163 may be disposed on a rear surface 100c of the mobile terminal 100.

A power/reset button 161d, a volume control button 161f, a terrestrial DMB antenna 141a for reception of broadcasting, and one or more microphones 162 may be disposed on a side surface 100b of the mobile terminal 100. The DMB antenna 141a may be secured to the mobile terminal 100 or may be detachably formed in the mobile terminal 100. The volume control button 161f includes increase volume button 161e and decrease volume button 161g.

Further, the mobile terminal 100 has the connector 165 arranged on a side surface of a lower end thereof. A plurality of electrodes is formed in the connector 165, and the connector 165 may be connected to an external device by a wire. The earphone connection jack 167 may be formed on a side surface of an upper end of the mobile terminal 100. An earphone may be inserted into the earphone connection jack 167.

Further, the input unit 168 may be mounted to a side surface of a lower end of the mobile terminal 100. The input unit 168 may be inserted and stored in the mobile terminal 100, and withdrawn and separated from the mobile terminal 100 when it is used.

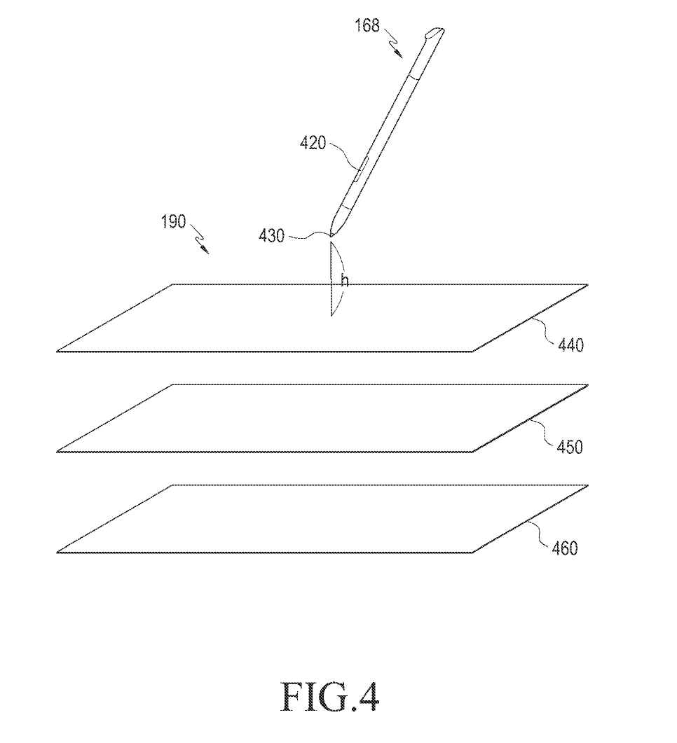

FIG. 4 is an exploded view schematically illustrating a screen, in which an input unit is hovering on the screen according to an embodiment of the present disclosure.

Referring to FIG. 4, the touch screen 190 may include the touch recognition panel 440, the display panel 450, and the pen recognition panel 460. The display panel 450 may be a panel such as a LCD panel or an AMOLED panel, and display various operation statuses of the mobile terminal 100, various images according to execution and a service of an application, and a plurality of objects.

The touch recognition panel 440 is an electrostatic capacitive type touch panel, in which a thin metal conductive material (i.e., Indium Tin Oxide (ITO) film), is coated on both surfaces of glass so as to allow electric current to flow, and dielectric for storing electric charges is coated thereon. When a user's finger touches the surface of the touch recognition panel 440, an amount of electric charges is moved by static electricity to a position at which the touch is achieved, and the touch recognition panel 440 recognizes a variation of electric current according to the movement of the electric charges, so as to detect the position at which the touch is achieved. All touches which may cause static electricity may be detected by the touch recognition panel 440.

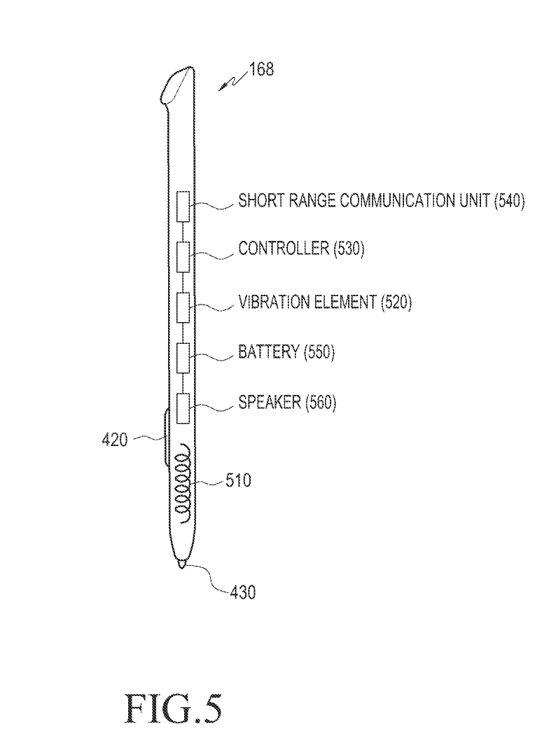

The hovering recognition panel 460 is an Electronic Magnetic Resonance (EMR) type touch panel, which includes an electronic induction coil sensor (not shown) having a grid structure including a plurality of loop coils arranged in a predetermined first direction and a second direction intersecting the first direction, and an electronic signal processor (not shown) for sequentially providing an Alternate Current (AC) signal having a predetermined frequency to each loop coil of the electronic induction coil sensor. If the input device 168 in which a resonance circuit is embedded, is present near the loop coil of the pen recognition touch panel 460, a magnetic field transmitted from a corresponding loop coil causes electric current in the resonance circuit in the input device 168, based on a mutual electronic induction. Accordingly, an induction magnetic field is created from a coil (not shown) constituting the resonance circuit in the input unit 168 based on the electric current, and the pen recognition panel 460 detects the induction magnetic field from the loop coil staying in a state of receiving signals so as to sense a hovering position or a touch position of the input unit 168. Also, the mobile terminal 100 senses a height h from the touch recognition panel 440 to a nib 430 of the input unit 168. It will be easily understood by those skilled in the art that the height h from the touch recognition panel 440 of the touch screen 190 to the nib 430 may be changed in correspondence to a performance or a structure of the mobile terminal 100. If an input unit may generate electric current based on electromagnetic induction, the pen recognition panel 460 may sense a hovering and a touch of the input unit. Accordingly, it will be described that the pen recognition panel 460 is exclusively used for sensing the hovering or the touch of the input unit 168. The input unit 168 may be referred to as an electromagnetic pen or an EMR pen. Further, the input unit 168 may be different from a general pen which has no resonance circuit, a signal of which is detected by the touch recognition panel 440. The input unit 168 may include a button 420 that may vary an electromagnetic induction value generated by a coil that is disposed, in an interior of a penholder, adjacent to the pen point 430. The input unit 168 will be more specifically described below with reference to FIG. 5.

On the other hand, the screen controller 195 may include a touch recognition controller and a pen recognition controller. The touch recognition controller converts analog signals received from the touch recognition panel 440 sensing a touch of a finger, into digital signals (i.e., X, Y and Z coordinates), and transmits the digital signals to the controller 110. The pen recognition controller converts analog signals received from the pen recognition panel 460 sensing a hovering or a touch of an input unit 168, into digital signals, and transmits the digital signals to the controller 110. Then, the controller 110 may control the touch recognition panel 440, the display panel 450, and the pen recognition panel 460 by using the digital signals received from the touch recognition controller and the pen recognition controller respectively. For example, the controller 110 may display a shape in a predetermined form on the display panel 450 in response to the hovering event or the touch of the finger, the pen, or the input unit 168.

Accordingly, in the mobile terminal 100 according to the embodiment of the present disclosure, the touch recognition panel may sense the touch of the user's finger or the pen, and the pen recognition panel also may sense the hovering or the touch of the input unit 168. Further, in the mobile terminal 100 according to the embodiment of the present disclosure, the pen recognition panel may sense the touch of the user's finger or the pen, and the touch recognition panel also may sense the hovering or the touch of the input unit 168. However, the structure of each panel may be modified in design. The controller 110 of the mobile terminal 100 may distinctively sense the touch by the user's finger or the pen, and the hovering event or the touch by the input unit 168. Further, although FIG. 4 shows only one screen, the present disclosure is not limited to one screen and may include a plurality of screens. Moreover, the screens may be included in the housings respectively and connected with each other by hinges, or a plurality of screens may be included in one housing. Furthermore, each of the plurality of screens includes the display panel and at least one pen/touch recognition panel as shown in FIG. 4.

FIG. 5 is a block diagram illustrating an input unit according to an embodiment of the present disclosure.

Referring to FIG. 5, the input unit 168 (e.g., a touch pen), according to the embodiment of the present disclosure may include a penholder; a pen point 430 disposed at an end of the penholder; a button 420 which may vary an electromagnetic induction value generated by a coil 510 which is disposed in an interior of the penholder to be adjacent to the pen point 430; a vibration element 520 that vibrates when a hovering input effect is generated; a controller 530 that analyzes a control signal received from the mobile terminal 100 due to the hovering over the mobile terminal 100, and controls a vibration intensity and a vibration period of the vibration element 520 of the input unit 168 according to the analysis; a short range communication unit 540 that performs short range communication with the mobile terminal 100; and a battery 550 that supplies an electric power for a vibration of the input unit 168. Further, the input unit 168 may include a speaker 560 which outputs a sound corresponding to the vibration intensity and/or the vibration period of the input unit 168.

The input unit 168 having such a configuration as described above supports an electrostatic induction scheme. When a magnetic field is formed at a predetermined position of the touch screen 190 by the coil 510, the touch screen 190 is configured to detect a position of the corresponding magnetic field to recognize a touch position.

Particularly, the speaker 560 may output sounds corresponding to various signals (e.g., radio signals, broadcasting signals, digital audio files, digital video files or the like), provided from the mobile communication module 120, the sub-communication module 130, or the multimedia module 140 embedded in the mobile terminal 100 under the control of the controller 530. Further, the speaker 560 may output sounds (e.g., a button operation tone corresponding to a voice call, or a ring tone), corresponding to functions that the portable terminal 100 performs, and one or a plurality of speakers 560 may be installed at a proper location or locations of the housing of the input unit 168.

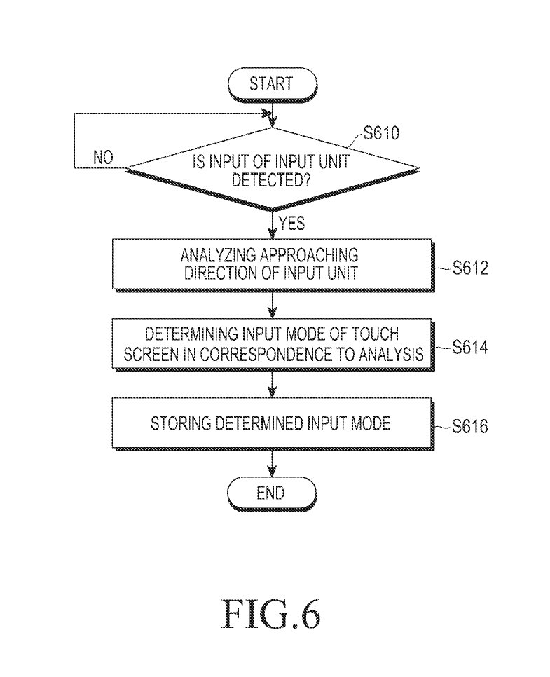

FIG. 6 is a flowchart illustrating a process of setting a screen mode of a mobile terminal according to an embodiment of the present disclosure.

Referring to FIG. 6, if an input of the input unit 168 is detected in operation S610, an approaching direction of the input unit 168 is analyzed in operation S612. The controller 110 may analyze an approaching direction of the input unit 168 through a movement of the input unit from a first area in which an input of the input unit 168 is detected to a second area distinguished from the first region. The first and second areas may have sizes which are variably adjusted, respectively. Further, the controller 110 may analyze the approaching direction or a progressing direction of the input unit 168 through an area (or point) in which an input of the input unit 168 or the user's finger is detected and an area (or point) in which the input of the input unit 168 after the predetermined time lapse is detected. The input includes the touch or the hovering on the screen. The controller 110 may analyze at least one of the approaching direction or the progressing direction of the input unit 168 through an area (or point) in which an initial hovering input of the input unit 168 is detected and an area (or point) in which the input unit 168 touches the screen. That is, if the notes are written by using the input unit 168, a touch starts at a point at which the notes are written. Before the notes are written, the input unit 168 is maintained in a hovering state. The controller 110 may determine an area (or point) in which the hovering according to the progressing direction of the input unit 168 is detected and an area (or point) which the input unit 168 touches on the screen, through this pattern, and also determine the progressing direction through this pattern. Further, the controller 110 may distinguish the hand holding the input unit 168 through the approaching direction of the input unit 168. The distinction of the hand holding the input unit 168 through the progressing direction of the input unit 168 is on the basis of a principle in which if a user generally holds the input unit 168 with a right hand, the input unit 168 is moved from right to left on the screen, while if the user holds the input unit 168 with a left hand, the input unit 168 is moved from left to right. In these cases, the hand holding the input unit may be distinguished through the moving direction of the input unit 168. The controller 110 may determine the progressing direction of the input unit and the hand holding the input unit 168 through the user experience. On the other hand, the approaching direction of the input unit 168 may be changed according to the hand holding the input unit 168 or the rotation status of the mobile terminal. Typically, if the user holds the input unit 168 with the right hand, the input unit 168 approaches in a direction from right to left of the screen. However, this is merely exemplary, and the present disclosure may detect the input unit 168 moving from left to right on the screen although the user holds the input unit 168 with the right hand. Furthermore, the controller 110 may analyze the rotation state of the mobile terminal. The mobile terminal may rotate in a range of 0 to 360 degrees with respect to the initial status, and the controller 110 may analyze a rotation angle of the mobile terminal through the sensor module 170. As described above, the mobile terminal 100 may determine a coordinate value according to the approaching direction of the hand holding the input unit 168 and the rotation angle of 0 to 360 degrees thereof. That is, the mobile terminal 100 may determine the rotation angle thereof by comparing a preset critical value or critical range with the extent of the rotation, and previously define the coordinate value according to the determination. The preset critical value or the critical range may be differently set according to each manufacturer of the mobile terminal, or may be variably adjusted. It is possible to actively respond to the rotation of the mobile terminal by adaptively applying the coordinate value according to the rotation of the mobile terminal.

The input mode of the screen is determined in operation S614 in correspondence to an analysis result of operation S612, and the determined input mode is stored in operation S616. The controller 110 determines the input mode by using the approaching direction of the input unit 168 and the rotation state of the mobile terminal. There are plural input modes according to the hand holding the input mode and/or the mobile terminal. The input mode includes a first mode in which the input unit 168 is held with the right hand and the input is performed, or a second mode in which the input unit 168 is held with the left hand and the input is performed. Further, the rotation state includes a status of the mobile terminal rotated clockwise by a predetermined angle from the initial state in which the mobile terminal is placed (i.e., the state in which the mobile terminal is placed so that the home button 161a is located at an upper side), a lower side, a left side, or a right side of the mobile terminal. Furthermore, the rotation state of the mobile terminal includes a first state in which the mobile terminal is placed at the initial state, a second state in which the mobile terminal rotates clockwise by 90 degrees from the initial state, a third state in which the mobile terminal rotates clockwise by 180 degrees from the initial state, and a fourth state in which the mobile terminal rotates clockwise by 270 degrees from the initial state. In addition, the input modes correspond to 0 degrees, 90 degrees, 180 degrees and 270 degrees, respectively, and also may be changed according to the rotation of the mobile terminal by units of 1 degree. Moreover, the controller 110 applies the predetermined coordinate value corresponding to the determined input mode to the screen, and stores the input mode to which the predetermined coordinate value. The controller 110 adds the predetermined coordinate value to a coordinate value of the screen.

In addition, the controller 110 may analyze at least one of the approaching direction and the changed state of the mobile terminal in correspondence to at least one of a re-approaching direction of the input unit 168 and a changed rotation state of the mobile terminal, and select the input mode corresponding to the analyzed approaching direction. Further, the controller 110 may select a mode corresponding to the analysis result and the rotation angle of the mobile terminal, among the plural input modes which were previously stored according to the approaching direction of the input unit 168 and the rotation angle of the mobile terminal. Furthermore, the controller 110 may maintain the screen in the previously applied input mode when the approaching of the input unit 168 is detected on the screen.

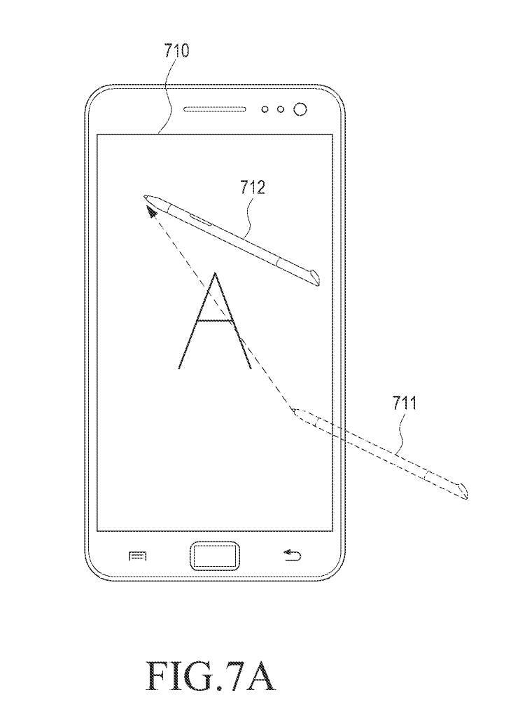

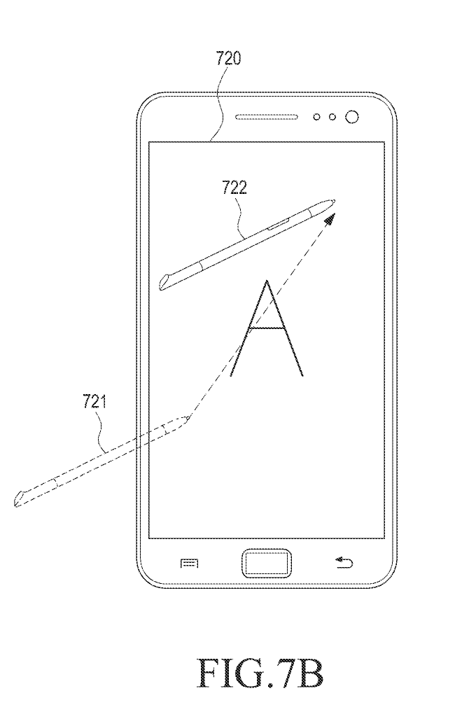

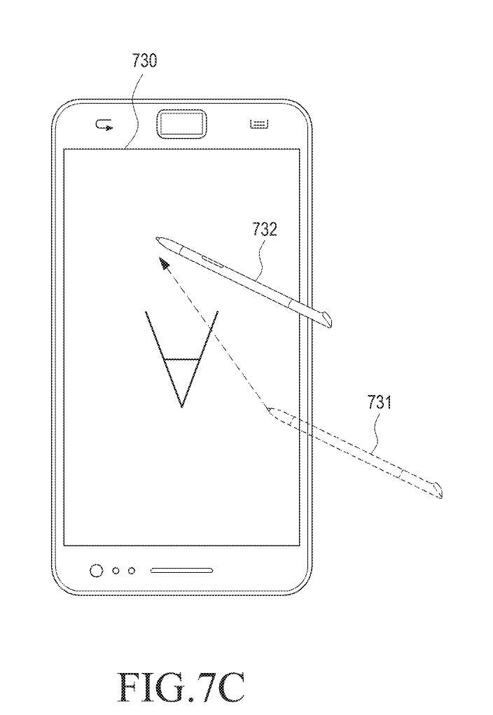

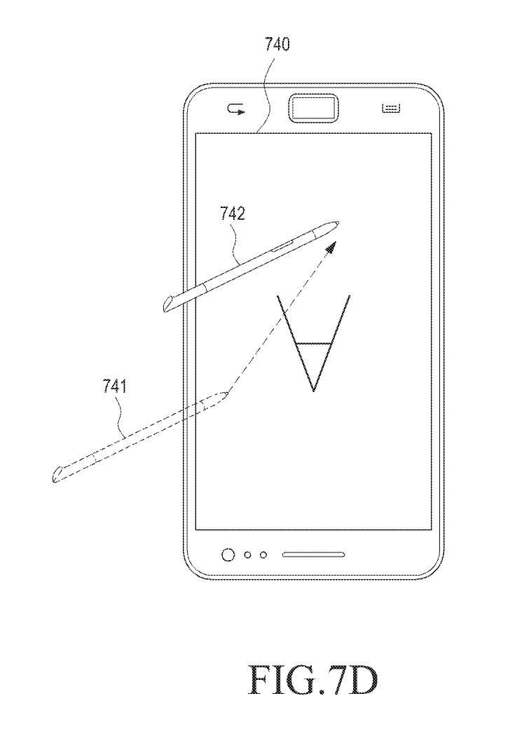

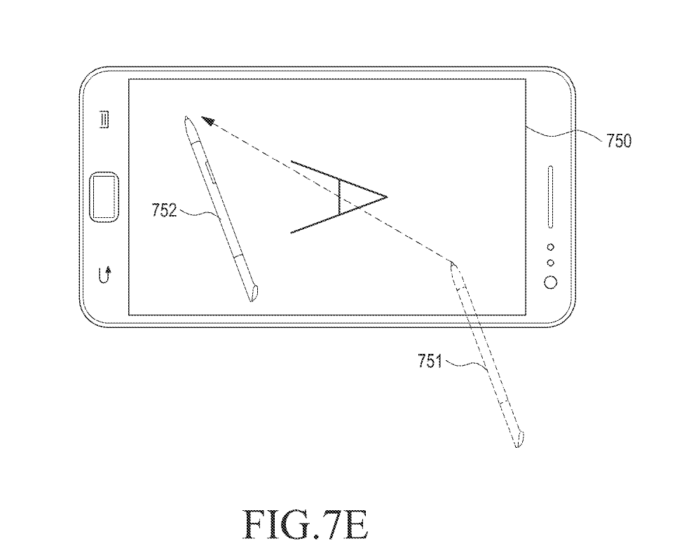

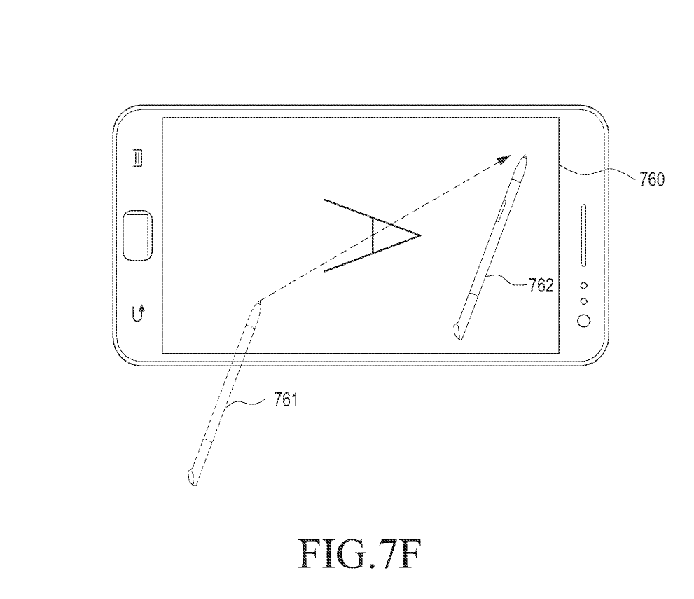

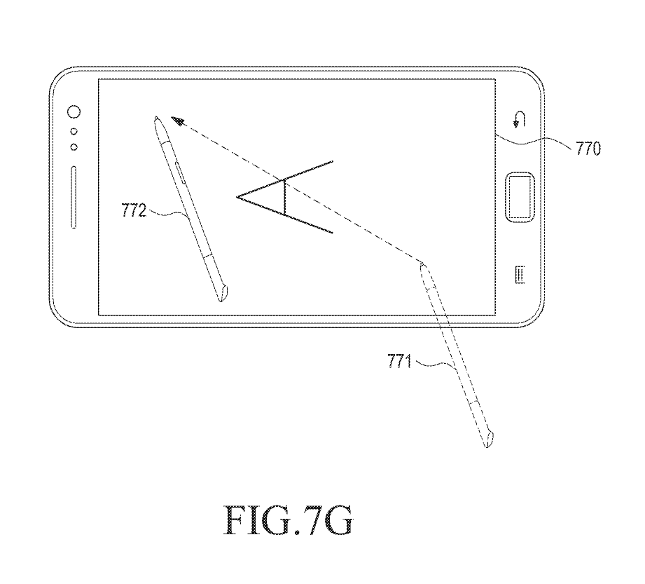

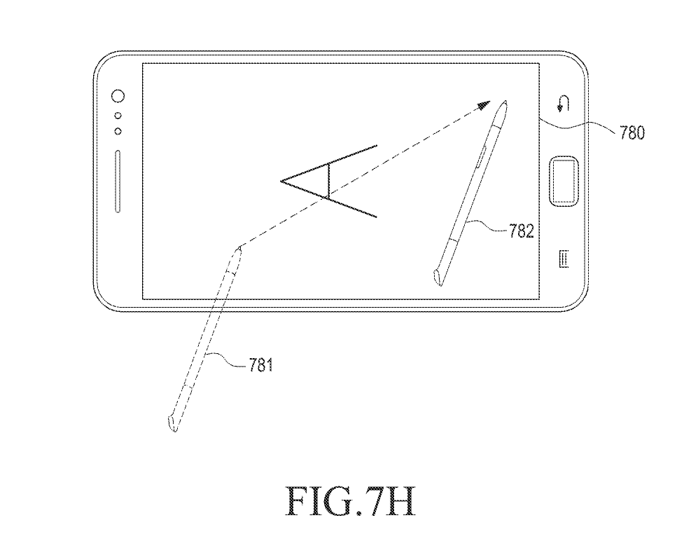

FIGS. 7A to 7H are front views illustrating a mobile terminal, in which a rotation state of the mobile terminal and an approaching direction of the input unit are exemplarily shown according to an embodiment of the present disclosure.

With relation to FIGS. 7A to 7H, FIG. 7A is a front view illustrating the mobile terminal, in which the input unit approaches the screen of the mobile terminal according to an embodiment of the present disclosure, FIG. 7B is a front view illustrating the mobile terminal, in which the input unit approaches the screen of the mobile terminal in another direction according to an embodiment of the present disclosure, FIG. 7C is a front view illustrating the mobile terminal, in which the mobile terminal rotates clockwise by 180 degrees and the input unit approaches the screen of the mobile terminal according to an embodiment of the present disclosure, FIG. 7D is a front view illustrating the mobile terminal according to an embodiment of the present disclosure, in which the mobile terminal rotates clockwise by 180 degrees and the input unit approaches the screen of the mobile terminal in another direction, FIG. 7E is a front view illustrating the mobile terminal according to an embodiment of the present disclosure, in which the mobile terminal rotates clockwise by 90 degrees and the input unit approaches the screen of the mobile terminal, FIG. 7F is a front view illustrating the mobile terminal according to an embodiment of the present disclosure, in which the mobile terminal rotates clockwise by 90 degrees and the input unit approaches the screen of the mobile terminal in another direction, FIG. 7G is a front view illustrating the mobile terminal according to an embodiment of the present disclosure, in which the mobile terminal rotates clockwise by 270 degrees and the input unit approaches the screen of the mobile terminal, and FIG. 7H is a front view illustrating the mobile terminal according to an embodiment of the present disclosure, in which the mobile terminal rotates clockwise by 270 degrees and the input unit approaches the screen of the mobile terminal in another direction. Hereinafter, a first input unit refers to an input unit which is placed at a first location, and a second input unit refers to an input unit which is placed at a second location.

Referring to FIG. 7A, the mobile terminal is longitudinally located in front of a user. Usually, this location is frequently used. The screen 710 may detect the approaching of the first input unit 711 and determine that the first input unit 711 progresses to the second input unit 712, under the control of the controller 110. That is, the screen 710 may detect the progressing direction of the input unit (i.e., in a direction from the first input unit 711 to the second input unit 712), under the control of the controller 110. The first input unit 711 may be located at a position at which the first input unit 711 touches the screen 710 or is hovering on the screen 710. In addition, the second input unit 712 may be located at a position at which the second input unit 712 touches the screen 710 or is hovering on the screen 710. Moreover, the input unit may move straight from the location of the first input unit 711 to the second input unit 712 or along a path which is not straight, and the controller 110 may determine the hand holding the input unit and the progressing direction of the input unit through the moving path of the input unit. Further, the controller 110 may determine whether the hand holding the input unit is the left hand or the right hand through the extent of the rotation of the input unit. The reason for determining the hand holding the input unit through the progressing direction of the input unit is because the input unit is moved from the right side to the left side of the screen when the input unit is generally held with the right hand while the input unit is moved from the left side to the right side of the screen when the input unit is held with the left hand. Referring to FIG. 7A, it may be determined through the user experience that the input unit is held with the right hand. The controller 110 detects the approaching of the first input unit 711, and the second input unit 712, so as to determine the hand holding the input unit and the progressing direction of the input unit. In addition, the controller may analyze the extent of the rotation of the input unit to the screen 710. Further, in view of the input unit of FIG. 7A progressing from the first input unit 711 on the right side to the second input unit 712 on the left side, it is determined that the input unit is held with the right hand. In this case, the controller 110 determines that the rotation angle of the mobile terminal is 0 degrees and the hand holding the input unit is the right hand, and extracts the predetermined coordinate value satisfying the condition from a previously stored table.

Referring to FIG. 7B, the mobile terminal is longitudinally placed in front of a user. Usually, this location is frequently used. The screen 720 may detect the approaching of the first input unit 721 and determine that the first input unit 721 progresses to the second input unit 722, under the control of the controller 110. That is, the screen 720 may detect the progressing direction of the input unit (i.e., in a direction from the first input unit 721 to the second input unit 722), under the control of the controller 110. The first input unit 721 may be located at a position at which the first input unit 721 touches the screen 720 or is hovering on the screen 720. In addition, the second input unit 722 may be located at a position at which the second input unit 722 touches the screen 720 or is hovering on the screen 720. Moreover, the input unit may move straight from the location of the first input unit 721 to the location of the second input unit 722 or along a path which is not straight, and the controller 110 may determine the hand holding the input unit and the progressing direction of the input unit through the moving path of the input unit. Further, the controller 110 may determine whether the hand holding the input unit is the left hand or the right hand through the extent of the rotation of the input unit. The reason for determining the hand holding the input unit through the progressing direction of the input unit is because the input unit is moved from the right side to the left side of the screen when the input unit is generally held with the right hand while the input unit is moved from the left side to the right side of the screen when the input unit is held with the left hand. Referring to FIG. 7B, it may be determined through the user experience that the input unit is held with the left hand. The controller 110 detects the approaching of the first input unit 721, and the second input unit 722, so as to determine the hand holding the input unit and the progressing direction of the input unit. In addition, the controller may analyze the extent of the rotation of the input unit to the screen 720. Further, in view of the input unit of FIG. 7B progressing from the first input unit 721 on the left side to the second input unit 722 on the right side, it is determined that the input unit is held with the left hand. In this case, the controller 110 determines that the rotation angle of the mobile terminal is 0 degrees and the hand holding the input unit is the left hand, and extracts the predetermined coordinate value satisfying the condition from a previously stored table.

Referring to FIG. 7C, the mobile terminal is placed in a state that the mobile terminal rotates clockwise by 180 degrees from the initial state. The screen 730 may detect the approaching of the first input unit 731 and determine that the first input unit 731 progresses to the second input unit 732, under the control of the controller 110. That is, the screen 730 may detect the progressing direction of the input unit (i.e., in a direction from the first input unit 731 to the second input unit 732), under the control of the controller 110. The first input unit 731 may be located at a position at which the first input unit 731 touches the screen 730 or is hovering on the screen 730. In addition, the second input unit 732 may be located at a position at which the second input unit 732 touches the screen 730 or is hovering on the screen 730. Moreover, the input unit may move straight from the location of the first input unit 731 to the location of the second input unit 732 or along a path which is not straight, and the controller 110 may determine the hand holding the input unit and the progressing direction of the input unit through the moving path of the input unit. Further, the controller 110 may determine whether the hand holding the input unit is the left hand or the right hand through the extent of the rotation of the input unit. Accordingly, referring to FIG. 7C, it may be determined through the user experience that the input unit is held with the right hand. The controller 110 detects the approaching of the first input unit 731, and the second input unit 732, so as to determine the hand holding the input unit and the progressing direction of the input unit. In addition, the controller may analyze the extent of the rotation of the input unit to the screen 730. Further, in view of the input unit of FIG. 7C progressing from the first input unit 731 on the right side to the second input unit 732 on the left side, it is determined that the input unit is held with the right hand. In this case, the controller 110 determines that the rotation angle of the mobile terminal is 180 degrees and the hand holding the input unit is the right hand, and extracts the predetermined coordinate value satisfying the condition from a previously stored table.

Referring to FIG. 7D, the mobile terminal is placed in a state that the mobile terminal rotates clockwise by 180 degrees from the initial state. The screen 740 may detect the approaching of the first input unit 741 and determine that the first input unit 741 progresses to the second input unit 742, under the control of the controller 110. That is, the screen 740 may detect the progressing direction of the input unit (i.e., in a direction from the first input unit 741 to the second input unit 742), under the control of the controller 110. The first input unit 741 may be located at a position at which the first input unit 741 touches the screen 740 or is hovering on the screen 740. In addition, the second input unit 742 may be located at a position at which the second input unit 742 touches the screen 740 or is hovering on the screen 740. Moreover, the input unit may move straight from the location of the first input unit 741 to the location of the second input unit 742 or along a path which is not straight, and the controller 110 may determine the hand holding the input unit and the progressing direction of the input unit through the moving path of the input unit. Further, the controller 110 may determine whether the hand holding the input unit is the left hand or the right hand through the extent of the rotation of the input unit. Accordingly, referring to FIG. 7D, it may be determined through the user experience that the input unit is held with the left hand. The controller 110 detects the approaching of the first input unit 741, and the second input unit 742, so as to determine the hand holding the input unit and the progressing direction of the input unit. In addition, the controller may analyze the extent of the rotation of the input unit to the screen 740. Further, in view of the input unit of FIG. 7D progressing from the first input unit 741 on the left side to the second input unit 742 on the right side, it is determined that the input unit is held with the left hand. In this case, the controller 110 determines that the rotation angle of the mobile terminal is 180 degrees and the hand holding the input unit is the left hand, and extracts the predetermined coordinate value satisfying the condition from a previously stored table.

Referring to FIG. 7E, the mobile terminal is placed in a state that the mobile terminal rotates clockwise by 90 degrees from the initial state. The screen 750 may detect the approaching of the first input unit 751 and determine that the first input unit 751 progresses to the second input unit 752, under the control of the controller 110. That is, the screen 750 may detect the progressing direction of the input unit (i.e., in a direction from the first input unit 751 to the second input unit 752), under the control of the controller 110. The first input unit 751 may be located at a position at which the first input unit 751 touches the screen 750 or is hovering on the screen 750. In addition, the second input unit 752 may be located at a position at which the first input unit 752 touches the screen 750 or is hovering on the screen 750. Moreover, the input unit may move straight from the location of the first input unit 751 to the location of the second input unit 752 or along a path which is not straight, and the controller 110 may determine the hand holding the input unit and the progressing direction of the input unit through the moving path of the input unit. Further, the controller 110 may determine whether the hand holding the input unit is the left hand or the right hand through the extent of the rotation of the input unit. Accordingly, referring to FIG. 7E, it may be determined through the user experience that the input unit is held with the right hand. The controller 110 detects the approaching of the first input unit 751, and the second input unit 752, so as to determine the hand holding the input unit and the progressing direction of the input unit. In addition, the controller may analyze the extent of the rotation of the input unit to the screen 750. Further, in view of the input unit of FIG. 7E progressing from the first input unit 751 on the right side to the second input unit 752 on the left side, it is determined that the input unit is held with the right hand. In this case, the controller 110 determines that the rotation angle of the mobile terminal is 90 degrees and the hand holding the input unit is the right hand, and extracts the predetermined coordinate value satisfying the condition from a previously stored table.

Referring to FIG. 7F, the mobile terminal is placed in a state that the mobile terminal rotates clockwise by 90 degrees from the initial state. The screen 760 may detect the approaching of the first input unit 761 and determine that the first input unit 761 progresses to the second input unit 762, under the control of the controller 110. That is, the screen 760 may detect the progressing direction of the input unit (i.e., in a direction from the first input unit 761 to the second input unit 762), under the control of the controller 110. The first input unit 761 may be located at a position at which the first input unit 761 touches the screen 760 or is hovering on the screen 760. In addition, the second input unit 762 may be located at a position at which the second input unit 762 touches the screen 760 or is hovering on the screen 760. Moreover, the input unit may move straight from the location of the first input unit 761 to the location of the second input unit 762 or along a path which is not straight, and the controller 110 may determine the hand holding the input unit and the progressing direction of the input unit through the moving path of the input unit. Further, the controller 110 may determine whether the hand holding the input unit is the left hand or the right hand through the extent of the rotation of the input unit. Accordingly, referring to FIG. 7F, it may be determined through the user experience that the input unit is held with the left hand. The controller 110 detects the approaching of the first input unit 761, and the second input unit 762, so as to determine the hand holding the input unit and the progressing direction of the input unit. In addition, the controller may analyze the extent of the rotation of the input unit to the screen 760. Further, in view of the input unit of FIG. 7F progressing from the left side 761 to the right side 762, it is determined that the input unit is held with the left hand. In this case, the controller 110 determines that the rotation angle of the mobile terminal is 90 degrees and the hand holding the input unit is the left hand, and extracts the predetermined coordinate value satisfying the condition from a previously stored table.

Referring to FIG. 7G, the mobile terminal is placed in a state that the mobile terminal rotates clockwise by 270 degrees from the initial state. The screen 770 may detect the approaching of the first input unit 771 and determine that the first input unit 771 progresses to the second input unit 772, under the control of the controller 110. That is, the screen 770 may detect the progressing direction of the input unit (i.e., in a direction from the first input unit 771 to the second input unit 772), under the control of the controller 110. The first input unit 771 may be located at a position at which the first input unit 771 touches the screen 770 or is hovering on the screen 770. In addition, the second input unit 772 may be located at a position at which the second input unit 772 touches the screen 770 or is hovering on the screen 770. Moreover, the input unit may move straight from the location of the first input unit 771 to the location of the second input unit 772 or along a path which is not straight, and the controller 110 may determine the hand holding the input unit and the progressing direction of the input unit through the moving path of the input unit. Further, the controller 110 may determine whether the hand holding the input unit is the left hand or the right hand through the extent of the rotation of the input unit. Accordingly, referring to FIG. 7E, it may be determined through the user experience that the input unit is held with the right hand. The controller 110 detects the approaching of the first input unit 771, and the second input unit 772, so as to determine the hand holding the input unit and the progressing direction of the input unit. In addition, the controller may analyze the extent of the rotation of the input unit to the screen 770. Further, in view of the input unit of FIG. 7G progressing from the first input unit 771 on the right side to the second input unit 772 on the left side, it is determined that the input unit is held with the right hand. In this case, the controller 110 determines that the rotation angle of the mobile terminal is 270 degrees and the hand holding the input unit is the right hand, and extracts the predetermined coordinate value satisfying the condition from a previously stored table.

Referring to FIG. 7H, the mobile terminal is placed in a state that the mobile terminal rotates clockwise by 270 degrees from the initial state. The screen 780 may detect the approaching of the first input unit 781 and determine that the first input unit 781 progresses to the second input unit 782, under the control of the controller 110. That is, the screen 780 may detect the progressing direction of the input unit (i.e., in a direction from the first input unit 781 to the second input unit 782), under the control of the controller 110. The first input unit 781 may be located at a position at which the first input unit 781 touches the screen 780 or is hovering on the screen 780. In addition, the second input unit 782 may be located at a position at which the second input unit 781 touches the screen 780 or is hovering on the screen 780. Moreover, the input unit may move straight from the location of the first input unit 781 to the location of the second input unit 782 or along a path which is not straight, and the controller 110 may determine the hand holding the input unit and the progressing direction of the input unit through the moving path of the input unit. Further, the controller 110 may determine whether the hand holding the input unit is the left hand or the right hand through the extent of the rotation of the input unit. Accordingly, referring to FIG. 7H, it may be determined through the user experience that the input unit is held with the left hand. The controller 110 detects the approaching of the first input unit 781, and the second input unit 782, so as to determine the hand holding the input unit and the progressing direction of the input unit. In addition, the controller may analyze the extent of the rotation of the input unit to the screen 780. Further, in view of the input unit of FIG. 7H progressing from the first input unit 781 on the left side to the second input unit 782 on the right side, it is determined that the input unit is held with the left hand. In this case, the controller 110 determines that the rotation angle of the mobile terminal is 270 degrees and the hand holding the input unit is the left hand, and extracts the predetermined coordinate value satisfying the condition from a previously stored table.

Although the mobile terminal which rotates by 0 degrees, 90 degrees, 180 degrees, and 270 degrees has been described with reference to FIGS. 7A, 7B, 7C, 7D, 7E, 7F and 7H, the rotation angles of the mobile terminal are merely exemplary. The present disclosure may detect the rotation of the mobile terminal even though the mobile terminal rotates by a specific angle of 0 to 360 degrees, and the present disclosure may be applied to the mobile terminal which rotates by the specific angle.

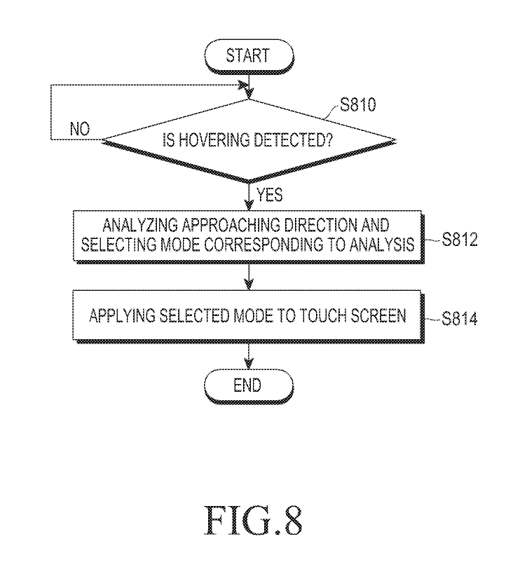

FIG. 8 is a flowchart illustrating a process of converting a screen mode of the mobile terminal according to an embodiment of the present disclosure.

Referring to FIG. 8, if the hovering of the input unit is detected in operation S810, the approaching direction of the input unit is analyzed and the mode corresponding to the approaching direction is selected in operation S812. The controller 110 analyzes the approaching direction of the input unit on the screen, and selects the input mode of the screen in consideration of the analyzed approaching direction and the rotation angle of the mobile terminal. Further, the controller 110 analyzes the progressing direction of the input unit with reference to a point at which an initial hovering input of the input unit is detected and a point at which the input unit touches the screen. In addition, the controller 110 may analyze the approaching direction or the progressing direction of the input unit through a point at which the input of the input unit is detected and a point at which an input is detected after a predetermined time lapse. The input includes the touch or the hovering on the screen. Further, the controller 110 may determine whether the hand holding the input unit is the left hand or the right hand through the approaching direction of the input unit. On the other hand, the approaching direction of the input unit may be changed according to the hand holding the input unit or the rotation status of the mobile terminal. Typically, if the user holds the input unit with the right hand, the input unit approaches in a direction from right to left of the screen. However, this is merely exemplary, and the present disclosure may detect the input unit moving from left to right on the screen although the user holds the input unit with the right hand. In addition, the controller 110 analyzes at least one of the approaching direction and the changed status of the mobile terminal in correspondence to at least one of a re-approaching direction of the input unit and a changed rotation status of the mobile terminal, and selects the input mode corresponding to the analyzed approaching direction. The controller 110 determines the hand holding the input unit through the approaching direction of the input unit. The input mode is selected through the approaching direction or the progressing direction of the input unit and the rotation status or angle of the mobile terminal. Further, the controller 110 may select a mode corresponding to the analysis result and the rotation angle of the mobile terminal, among the plural input modes which were previously stored according to the approaching direction of the input unit and the rotation angle of the mobile terminal. There are plural input modes according to the progressing direction of the input unit, the hand holding the input unit, and the rotation angle of the mobile terminal. For example, the plural input modes include modes which correspond to a first state in which the mobile terminal is placed at the initial state in front of the user, a second state in which the mobile terminal rotates clockwise by 90 degrees from the initial state, a third state in which the mobile terminal rotates clockwise by 180 degrees from the initial state, and a fourth state in which the mobile terminal rotates clockwise by 270 degrees, when the input unit is held with the hand. The present disclosure may determine four states of the mobile terminal as described above, and also determine the rotation angle of the mobile terminal even though the mobile terminal rotates by any angle of the rotation angles 0 to 360. Furthermore, the plural input modes may have different coordinate values respectively according to the rotation angle. The controller 110 applies the preset coordinate value, which corresponds to the selected mode among the plurality input modes according to the analysis result, to the screen.

The mode selected in operation S812 is applied to the screen in operation S814. In the mode applied to the screen (i.e., the input mode), a coordinate of the screen is moved by a coordination value corresponding to the selected input mode. Further, the controller 110 may maintain the screen in the previously applied input mode when the approaching of the input unit is detected on the screen. In addition, the controller 110 may analyze at least one of the approaching direction of the input unit and the changed state of the mobile terminal again, when at least one of a re-approaching direction of the input unit and a changed rotation state of the mobile terminal is changed, and select the input mode corresponding to the analyzed approaching direction.

It may be appreciated that the various embodiments of the present disclosure may be implemented in software, hardware, or a combination thereof. Any such software may be stored, for example, in a volatile or non-volatile storage device such as a ROM, a memory such as a RAM, a memory chip, a memory device, or a memory IC, a recordable optical or magnetic medium such as a CD, a DVD, a magnetic disk, or a magnetic tape, regardless of its ability to be erased or its ability to be re-recorded, and a machine readable storage medium (e.g., a computer readable storage medium). It will be appreciated that a memory, which may be incorporated in a mobile terminal, may be an example of a machine-readable storage medium which is suitable for storing a program or programs including commands to implement the various embodiments of the present disclosure. Accordingly, the present disclosure includes a program that includes a code for implementing an apparatus or a method defined in any claim in the present specification and a machine-readable storage medium that stores such a program.

Moreover, the above-described mobile terminal may receive the program from a program providing device which is connected thereto in a wired or wireless manner, and store the program. The program providing device may include a program including instructions for enabling the mobile terminal to control the screen, a memory for storing information necessary for controlling the screen, a communication unit for performing a wired or wireless communication with the mobile terminal, and a controller for automatically transmitting a request of the mobile terminal or a corresponding program to the host device.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for controlling a screen of a mobile terminal, the method comprising:
analyzing an approaching direction of an input unit on the screen; and
determining an input mode of the screen in correspondence to the analysis.

2. The method as claimed in claim 1, further comprising:
applying a coordinate value corresponding to the determined input mode to the screen.

3. The method as claimed in claim 2, further comprising storing the determined input mode to which the coordinate value is applied.

4. The method as claimed in claim 1, wherein the analyzing of the approaching direction comprises:
analyzing the approaching direction of the input unit through a moving direction of the input unit from a first area in which an input of the input unit is detected to a second area distinguished from the first area.

5. The method as claimed in claim 1, wherein the determining of the input mode of the screen comprises:
determining the input mode by using the approaching direction of the input unit and a rotation state of the mobile terminal.

6. The method as claimed in claim 2, wherein the applying of the coordinate value comprises:
adding the coordinate value to a coordinate value of the screen.

7. The method as claimed in claim 5, wherein the rotation state of the mobile terminal includes a state in which the mobile terminal rotates clockwise by an angle from an initial state in which the mobile terminal is placed in front of a user's face.

8. The method as claimed in claim 1, wherein the determined input mode comprises a first mode in which an input is performed by holding the input unit with a right hand, and a second mode in which the input is performed by holding the input unit with a left hand.

9. The method as claimed in claim 5, wherein the rotation state of the mobile terminal comprises a first state in which the mobile terminal is placed in an initial state, a second state in which the mobile terminal rotates clockwise by 90 degrees from the initial state, a third state in which the mobile terminal rotates clockwise by 180 degrees from the initial state, and a fourth state in which the mobile terminal rotates clockwise by 270 degrees from the initial state.

10. The method as claimed in claim 4, wherein the input includes a touch or a hovering.

11. A method for controlling a screen of a mobile terminal, the method comprising:
analyzing an approaching direction of an input unit on the screen; and
selecting an input mode corresponding to the analyzed approaching direction; and
applying the selected input mode as an input mode of the screen.

12. The method as claimed in claim 11, wherein the analyzing of the approaching direction comprises:
analyzing the approaching direction of the input unit through a point at which an initial hovering input of the input unit is detected and a point at which the input unit touches the screen.

13. The method as claimed in claim 11, wherein the selected input mode is selected by using the approaching direction of the input unit and a rotation state of the mobile terminal.

14. The method as claimed in claim 11, further comprising:
analyzing at least one of the approaching direction of the input unit and a changed state of the mobile terminal in correspondence to at least one of a re-approaching of the input unit and a changed rotation state of the mobile terminal, and selecting an input mode corresponding to the analyzed approaching direction.

15. The method as claimed in claim 11, further comprising:
determining a hand holding the input unit through the approaching direction of the input unit.

16. The method as claimed in claim 11, wherein the selecting of the input mode comprises:
selecting a mode corresponding to a rotation angle of the mobile terminal and the analysis result from previously stored a plural input modes according to the approaching direction of the input unit and the rotation angle of the mobile terminal.

17. The method as claimed in claim 11, wherein the applied input mode is an input mode in which a coordinate of the screen is moved by a coordinate value corresponding to the selected input mode.

18. The method as claimed in claim 16, wherein the plural input modes include a mode in which the input unit is touched in any one state of a first state in which the mobile terminal is placed in an initial state, a second state in which the mobile terminal rotates clockwise by 90 degrees from the initial state, a third state in which the mobile terminal rotates clockwise by 180 degrees from the initial state, and a fourth state in which the mobile terminal rotates clockwise by 270 degrees from the initial state, when the input unit is held with a hand.

19. The method as claimed in claim 11, further comprising:
maintaining the applied input mode as the input mode of the screen if the approaching of the input unit on the screen is detected.

20. A mobile terminal for controlling a screen, the mobile terminal comprising:
the screen configured to supply notes; and
a controller configured to analyze an approaching direction of the input unit on the screen and to control determination of an input mode of the screen in correspondence to the analysis.

21. The mobile terminal as claimed in claim 20, wherein the controller is further configured to apply a coordinate value corresponding to the determined input mode to the screen.

22. The mobile terminal as claimed in claim 21, further comprising:
a storage unit configured to store the determined input mode to which the coordinate value is applied.

23. The mobile terminal as claimed in claim 20, wherein the controller is further configured to analyze the approaching direction of the input unit through a moving direction of the input unit from a first area in which an input of the input unit is detected to a second area distinguished from the first area.

24. The mobile terminal as claimed in claim 20, wherein the controller is further configured to determine the input mode by using the approaching direction of the input unit and a rotation state of the mobile terminal.

25. The mobile terminal as claimed in claim 21, wherein the controller is further configured to add the coordinate value to a coordinate value of the screen.

26. The mobile terminal as claimed in claim 24, wherein the rotation state of the mobile terminal includes a state in which the mobile terminal rotates clockwise by a angle from an initial state in which the mobile terminal is placed in front of a user's face.

27. The mobile terminal as claimed in claim 20, wherein the input mode includes a first mode in which an input is performed by holding the input unit with a right hand, and a second mode in which the input is performed by holding the input unit with a left hand.

28. The mobile terminal as claimed in claim 24, wherein the rotation state of the mobile terminal includes a first state in which the mobile terminal is placed in an initial state, a second state in which the mobile terminal rotates clockwise by 90 degrees from the initial state, a third state in which the mobile terminal rotates clockwise by 180 degrees from the initial state, and a fourth state in which the mobile terminal rotates clockwise by 270 degrees from the initial state.

29. The mobile terminal as claimed in claim 20, wherein the controller is further configured to analyze the approaching direction of the input unit through a point at which an initial hovering input of the input unit is detected and a point at which the input unit touches the screen.

30. The mobile terminal as claimed in claim 20, wherein the controller is further configured to analyze at least one of the approaching direction of the input unit and a changed state of the mobile terminal in correspondence to at least one of a re-approaching of the input unit and a changed rotation state of the mobile terminal, and to select an input mode corresponding to the analyzed approaching direction.

31. The mobile terminal as claimed in claim 20, wherein the controller is further configured to determine a hand holding the input unit through the approaching direction of the input unit.

32. The mobile terminal as claimed in claim 31, wherein the controller is further configured to select the input mode from a plural input modes which were previously stored, through the approaching direction of the input unit and the rotation angle of the mobile terminal.

33. The mobile terminal as claimed in claim 21, wherein the controller is further configured to maintain an input mode applied to the screen as the input mode of the screen if the approaching of the input unit is detected on the screen.

32. A non-transitory computer-readable storage medium storing instructions that, when executed, cause at least one processor to perform the method of claim 1.
